(19) United States
(12) Patent Application Publication
(10) Pub. No.: US 2013/0192566 A1
(43) Pub. Date: Aug. 1, 2013

(54) CONTROL SYSTEM HAVING CONFIGURABLE AUXILIARY POWER MODULE

(71) Applicant: Bahman GOZLOO, Peoria (IL)

(72) Inventor: Bahman GOZLOO, Peoria (IL)

(21) Appl. No.: 13/359,742

(22) Filed: Jan. 27, 2012

(51) Int. Cl. F02M 51/00; H02J 1/00

(52) U.S. Cl. 123/478; 307/38; 307/31

(57) ABSTRACT

A control system is disclosed for use with an engine. The control system may have a power source and a main control module configured to receive power from the power source and direct control signals to at least one component of the engine. The control system may also have an auxiliary power module that is selectively connectable to the main control module and to the power source. The auxiliary power module may be configured to receive power from the power source and direct control signals through the main control module to the at least one component of the engine.

### TECHNICAL FIELD

The present disclosure is directed to a control system and, more particularly, to a control system having a configurable auxiliary power module.

### BACKGROUND

Most modern engines are equipped with a control module that selectively supplies electrical power in the form of control signals to components of the engine during operation. For example, a conventional control module can receive power from an onboard battery, condition the power, and direct control signals of varying voltage levels to different fuel injectors of the engine such that the fuel injectors inject fuel at specific timings, durations, flow rates, and/or pressures. One such control module is disclosed in U.S. Patent Publication No. 2009/0192685 of Sime that published on Jul. 30, 2009 (“the '685 publication”).

Modern engines are constantly being adapted to new applications and/or modified to meet new requirements, and these engine adaptations and modifications often require corresponding changes in the associated control module. For example, when an engine grows from six cylinders to twenty cylinders, the associated control module may need to generate control signals that supply about three times more power to accommodate the additional fuel injectors. In another example, the waveform of current signals directed from the control module to the fuel injectors may need to produce a greater number of different voltage levels in order to meet changing emission, efficiency, and/or power goals of the associated engine. Each of these changes would historically require development of a new control module, which can be a costly and time consuming endeavor.

The control system of the present disclosure addresses one or more of the problems set forth above and/or other problems of the prior art.

### SUMMARY

One aspect of the present disclosure is directed to a control system for an engine. The control system may include a power source and a main control module configured to receive power from the power source and direct control signals to at least one component of the engine. The control system may also include an auxiliary power module that is selectively connectable to the main control module and to the power source. The auxiliary power module may be configured to receive power from the power source and direct control signals through the main control module to the at least one component of the engine.

Another aspect of the present disclosure is directed to a method of controlling an engine. The method may include directing power from a power source to a main control module, and conditioning power from the power source within the main control module. The method may also include directing power from the power source to an auxiliary power module, and conditioning power from the power source within the auxiliary power module. The method may further include directing conditioned power from the main control module to at least one component of the engine, and directing conditioned power from the auxiliary power module through the main control module to the at least one component of the engine.

### BRIEF DESCRIPTION OF THE DRAWINGS

FIG. 1 is a diagrammatic illustration of an exemplary disclosed engine; and

FIG. 2 is a schematic illustration of a control system that may be used in conjunction with the engine of FIG. 1.

### DETAILED DESCRIPTION

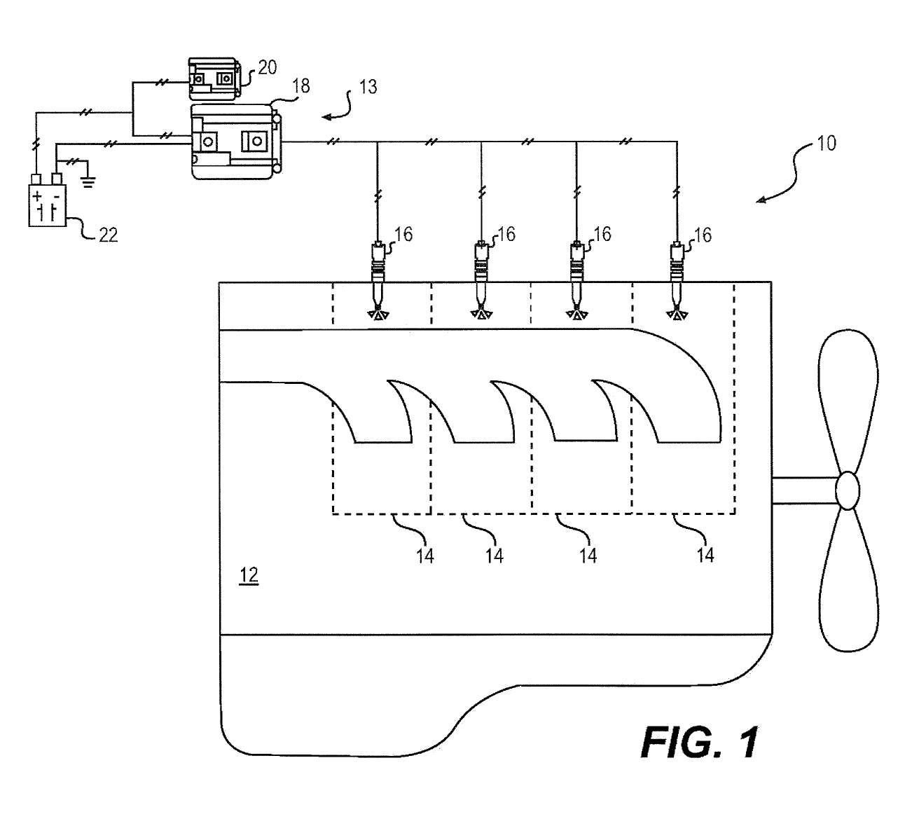

FIG. 1 illustrates an exemplary embodiment of an engine 10. For the purposes of this disclosure, engine 10 is depicted and described as a four-stroke diesel engine. One skilled in the art will recognize, however, that engine 10 may be another type of internal combustion engine such as, for example, a gasoline or a gaseous fuel-powered engine. Engine 10 may include an engine block 12 that at least partially defines a plurality of cylinders (not shown), a piston (not shown) slidably disposed within each cylinder, and a cylinder head (not shown) associated with each cylinder. The cylinders, pistons, and cylinder heads may together form a plurality of combustion chambers 14. In the illustrated embodiment, engine 10 includes four combustion chambers 14. However, it is contemplated that engine 10 may include a greater or lesser number of combustion chambers 14 and that combustion chambers 14 may be disposed in an “in-line” configuration, a “V” configuration, or in another suitable configuration. A fuel injector 16 and/or other components (not shown) may be associated with each combustion chamber 14 to support fuel combustion within engine 10 that generates a mechanical power output.

Engine 10 may be equipped with a control system 13 that regulates operation of engine 10. Control system 13 may include, among other things, a main control module 18, an auxiliary power module 20, and a power source 22. Power source 22 may provide electrical power to main control module 18 and to auxiliary power module 20. Main control module 18 and auxiliary power module 20, as will be explained in more detail below, may condition the electrical power from power source 22 and generate control signals (i.e., power output having desired parameters such as boosted voltage levels) directed to fuel injectors 16 via one or more switching field-effect transistors (EFTs) 23 and/or to other components of engine 10 to regulate operation of engine 10 in a desired manner.

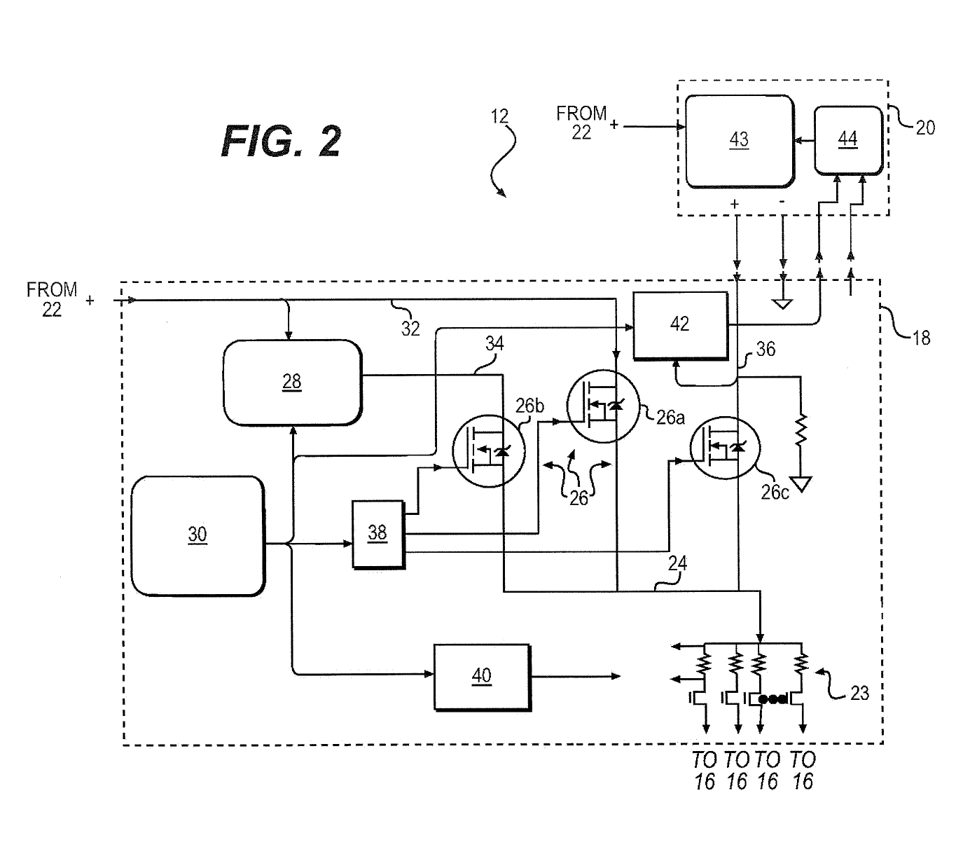

Main control module 18 may include a number of different components that cooperate to condition power from power source 22 and control operations of auxiliary power module 20 and engine 10. For example, FIG. 2 illustrates main control module 18 as including a common bus 24, a plurality of gates 26 (e.g., a first gate 26a, a second gate 26b, and a third gate 26c), power electronics 28, and a main controller 30. Common bus 24 may be in communication with each of fuel injectors 16 and configured to direct control signals from gates 26 to fuel injectors 16. Gates 26 may be configured to selectively close and complete different circuits that direct control signals (i.e., power output) at different voltage levels onto common bus 24. Power electronics 28 may be configured to condition power from power source 22, for example to receive power at a first voltage level and to boost the power to a second higher voltage level. Main controller 30 may be in communication with the other components of main control module 18 and configured to control operation of gates 26 and power electronics 28.

Common bus 24 may include positive and negative power lines that electrically interconnect gates 26 with fuel injectors 16 and/or other components of engine 10. Common bus 24 may also be electrically connected to accessory power loads to provide power to and remove power from common bus 24, if desired.

Gates 26 may include components that together function as electronic switches, which can be selectively closed by main controller 30 to thereby send signals of varying voltage levels to fuel injectors 16 via common bus 24. Gates 26, in the disclosed embodiment, are implemented using diodes or transistors, but can also be constructed using electromagnetic relays (relay logic), fluidic logic, pneumatic logic, optics, molecules, or even mechanical elements, if desired. Gate 26a may be associated with a first circuit 32 that communicates power source 22 directly with gate 26a. When gate 26a closes, a control signal having a first voltage level about the same as a supply voltage from power source 22 may be directed to injectors 16 via common bus 24. Gate 26b may be associated with a second circuit 34 that communicates power electronics 28 with gate 26b. When gate 26b closes, a control signal having a boosted second voltage level (i.e., a voltage that has been boosted by power electronics 28 to a level higher than the first voltage level) may be directed to injectors 16 via common bus 24. Gate 26c may be associated with a third circuit 36 that communicates auxiliary power module 20 with gate 26c. When gate 26c closes, a control signal having a boosted third voltage level (i.e., a voltage that has been boosted by auxiliary power module 20 to a level higher than the first voltage level) may be directed to injectors 16 via common bus 24. The third voltage level may be higher or lower than the second voltage level, as desired. It is contemplated that additional and/or different gates 26 may be included within main control module 18, if desired.

Power electronics 28 may include any components and/or have any configuration known in the art that are used to selectively condition a voltage level of power received power source 22. For example, power electronics 28 could include a capacitor circuit (not shown) that raises the voltage of supplied power to a sufficiently high level. It is contemplated that the voltage level of the power conditioned by power electronics 28 may be variable, if desired, and selectively controlled by main controller 30. It is also contemplated that power electronics 28 could alternatively lower the voltage level of the power, if desired.

Main controller 30 may embody a single microprocessor or multiple microprocessors that include a means for controlling an operation of main control module 18, auxiliary power module 20, and injectors 16. Numerous commercially available microprocessors can be configured to perform the functions of main controller 30. It should be appreciated that main controller 30 could readily embody a general machine or engine microprocessor capable of controlling numerous machine or engine functions. Main controller 30 may include all the components required to run an application such as, for example, a memory, a secondary storage device, and a processor, such as a central processing unit or any other means known. Various other known circuits may be associated with main controller 30, including power source circuitry (not shown), gate driver circuitry, injector control and diagnostic circuitry 40, auxiliary power module diagnostic and control circuitry 42, and other appropriate circuitry.

During operation of engine 10, main controller 30 may communicate with one or more drivers 38 associated with gates 26 to generate a waveform of different control signals sequentially sent to injectors 16 that results in injectors 16 advancing fuel into engine 10 at specific timings, for specific durations, in specific amounts, and/or at specific pressures. For example, main controller 30 may initially cause drivers 38 to close gate 26b and direct a control signal at the boosted second voltage level onto common bus 24 that initiates movement of valves (not shown) within injectors 16. The voltage level of this control signal may be elevated to overcome effects of inertia associated with initial movements of the valves. Main controller 30 may then cause drivers 38 to open gate 26b and close gate 26c to direct a second control signal onto common bus 24. Because the valves of injectors 16 may already be in motion at this time, the second control signal may require a lower voltage than the first control signal to adequately continue movement of the valves. A third control signal of the waveform may finally be directed onto common bus 24 via gate 26a and drivers 38. This final control signal may have a voltage level lower than the voltage levels of the first two control signals and be used to counteract a tendency of the valves within injectors 16 to bounce during movement toward an injecting position and to overcome hydraulic inertia of fuel in contact with the valves. By using control signals having different voltage levels, energy may be conserved and operation of fuel injectors 16 tightly controlled.

Auxiliary power module 20 may be mechanically and electrically connectable to main control module 18. Specifically, a housing of auxiliary power module 20 may be mechanically connectable to a housing of main control module 18, for example by way of pin-and-socket connection (not shown) and one or more fasteners (not shown). In addition, components of auxiliary power module 20, for example auxiliary power electronics 43 and an auxiliary controller 44, may be electrically connected to gate 26c and diagnostic and control circuitry 42 of main control module 18, respectively.

Power electronics 43, like power electronics 28, may include any components and/or have any configuration known the art used to selectively condition a voltage level of power received power source 22. For example, power electronics 43 could include a capacitor circuit (not shown) that raises the voltage to a level higher or lower than the power conditioned by power electronics 28. It is contemplated that the voltage level of the power conditioned by power electronics 43 may be variable, if desired, and selectively controlled by auxiliary controller 44 in response to instructions received from main controller 30 via diagnostic and control circuitry 42. It is also contemplated that power electronics 43 could alternatively lower the voltage level of the power, if desired

Auxiliary controller 44, like main controller 30, may embody a single microprocessor or multiple microprocessors that include a means for controlling an operation of auxiliary power module 20. Numerous commercially available microprocessors can be configured to perform the functions of auxiliary controller 44. Auxiliary controller 44 may include all the components required to run an application such as, for example, a memory, a secondary storage device, and a processor, such as a central processing unit or any other means known.

Auxiliary controller 44 may be configured to regulate operation of power electronics 43 based on instructions from main controller 30. For example, upon connection of auxiliary power module 20 to main control module 18, auxiliary controller 44 may receive instructions from main controller 30 regarding a desired voltage level of the power supplied through main control module 18 to common bus 20 and injectors 16. Auxiliary controller 44 may then monitor the voltage within third circuit 36 and responsively regulate operation of power electronics 43 to condition the power accordingly. Additionally or alternatively, auxiliary controller 44 may continuously receive instructions from main controller 30 during operation of engine 10 regarding desired changes in the voltage level of the power conditioned by power electronics 43. Auxiliary controller 44 may then regulate operation of power electronics 43 in response to these instructions. Auxiliary controller 44 may further be configured to implement a safe power-down of auxiliary power module 20 in response to auxiliary power module 20 being disconnected from main control module 18.

Power source 22 may be any appropriate power source known in the art. For example, power source 22 could embody the primary battery of engine 10 and be configured to produce direct current power having a predetermined voltage level. Alternatively, power source 22 could embody an alternator that is driven by engine 10 to produce alternating current, which could subsequently be converted to direct current used to power main control module 18, auxiliary power module 20, and/or injectors 16. Finally, power source 22 could be a stationary source of direct or alternating power not associated with engine 10, for example shore power, if desired.

### INDUSTRIAL APPLICABILITY

The control system of the present disclosure may have wide application in a variety of different technologies. For example, control system 13 may be applied to a mobile engine application such as in an earth-moving or construction machine application, or to a stationary application such as in a generator set or pumping application. Control system 13 may provide expanded control capacity and/or increased control functionality of the associated engine through the selective use of auxiliary power module 20. Operation of control system 13 will now be described in detail.

Main control module 18, together with power source 22, may be used in conjunction with any engine to control basic operations of any engine component. Main control module 18 may be configured to generate basic control signals having a limited number of different voltage levels (e.g., two) and having a limited capacity for control signal power. In this manner, main control module 18 may be economically produced in large numbers and be applicable to a greater number of engines without significant modification.

In some applications, however, the number of different voltage levels and/or the power capacity of control signals generated by main control module 18 may be insufficient. For example, a varying voltage level may be needed for various loads to compensate for mechanical wear and/or aging. Instead of replacing main control module 18 with a different control module having increased capacity and/or functionality, auxiliary power module 20 may be connected to the existing main control module 18. Auxiliary power module 20 may then be commanded to adjust to a desired level dynamically using one or more predefined algorithms and/or feedback mechanisms (not shown).

When auxiliary power module 20 is connected to main control module 18, main controller 30 of main control module 18 may provide instructions to auxiliary controller 44 of auxiliary power module 20 regarding a desired voltage level of control signals generated by power electronics 43. For example, main controller 30 may instruct auxiliary controller 44 to cause control signals to be produced that have a voltage level the same as, higher than, or lower than the voltage level of control signals already being produced by power electronics 28. Main controller 30 may then selectively activate gates 26 to incorporate the additional control signals from auxiliary power module 20 into the waveform sent to injectors 16 via common bus 24.

When power electronics 28 and 43 simultaneously boost control signals to the same voltage level, the capacity of control system 13 may be increased. For example, control system 13 may be able to power a greater number of injectors 16 with the same types of control signals when auxiliary power module 20 is connected to main power module 18. In this situation, main controller 30 may cause gates 26a and 26c to simultaneously close and connect both of power electronics 43 and 28 to common bus 24 at the same time.

When power electronics 28, 43 generate control signals having different voltage levels, the functionality of control system 13 may be increased. In particular, control system 13 may be capable of generating more complex waveforms that can be used to control operation of injectors 16 in a more precise manner. In this situation, main controller 40 may cause gates 26a, 26b, and 26c to selectively close at desired times and produce cohesive waveforms with greater complexity (i.e., with an increased number of different voltage levels).

During operation of engine 10, main controller 30 may be configured to monitor operation of power electronics 28 and 43, and make control system adjustments based on detected deviations of control signal voltages from desired voltage levels. For example, main controller 30 may detect (via injector control and diagnostic circuitry 40 and/or auxiliary power module diagnostic and control circuitry 42) an actual voltage level of control signals being directed through gates 26 to common bus 24, and compare the actual voltage levels to desired voltage levels. Based on the comparison, main controller 30 may then make direct adjustments to the operation of power electronics 28 or cause indirect adjustments to be made to power electronics 43 via instructions sent through auxiliary controller 44. Additionally or alternatively, main controller 30 may adjust operation of gates 26 to accommodate deviated voltage levels of the control signals.

Auxiliary power module 20 may be configured to automatically detect disconnection from main control module 18 and respond accordingly. Specifically, auxiliary controller 44 may be configured to detect a loss of communication with main controller 30 and, based on the detection, cause power electronics 43 to stop generating control signals. In this manner, auxiliary power module 20 may be made safe during service or trouble shooting of control system 13.

It will be apparent to those skilled in the art that various modifications and variations can be made to the control system of the present disclosure without departing from the scope of the disclosure. Other embodiments will be apparent to those skilled in the art from consideration of the specification and practice of the control system disclosed herein. It is intended that the specification and examples be considered as exemplary only, with a true scope of the disclosure being indicated by the following claims and their equivalents.

What is claimed is:

1. A control system for an engine, comprising:
a power source;
a main control module configured to receive power from the power source and direct control signals to at least one component of the engine; and
an auxiliary power module that is selectively connectable to the main control module and to the power source, the auxiliary power module being configured to receive power from the power source and direct control signals through the main control module to the at least one component of the engine.

2. The control system of claim 1, wherein the auxiliary power module is both mechanically and electrically connectable to the main control module.

3. The control system of claim 1, wherein the main control module includes:
first power electronics configured to receive power from the power source at a first voltage level and generate a power output at a boosted second voltage level; and
a controller in communication with the first power electronics and configured to selectively activate the first power electronics.

4. The control system of claim 3, wherein the auxiliary power module includes second power electronics configured to receive power from the power source at the first voltage level and generate a power output at a boosted third voltage level.

5. The control system of claim 4, wherein the controller is in further communication with the second power electronics and configured to selectively activate the second power electronics.

6. The control system of claim 5, wherein the main control module further includes:
a bus associated with the at least one component of the engine;
a first gate configured to selectively close a connection between the power source and the bus;
a second gate configured to selectively close a connection between the first power electronics and the bus; and
a third gate configured to selectively close a connection between the second power electronics and the bus.

7. The control system of claim 6, wherein:
the at least one component includes at least one fuel injector; and
the controller is configured to selectively activate the first power electronics, the second power electronics, the first gate, the second gate, and the third gate to generate a desired waveform having at least two different voltage levels directed to the at least one fuel injector.

8. The control system of claim 5, wherein the controller is configured to set the boosted third voltage level at startup of the auxiliary power module.

9. The control system of claim 8, wherein the controller is configured to adjust the boosted third voltage level during operation of the auxiliary power module.

10. The control system of claim 4, wherein the second power electronics are further configured to receive power from the power source at the first voltage level and generate the power output at the boosted second voltage level.

11. The control system of claim 3, wherein the auxiliary power module includes second power electronics configured to receive power from the power source at the first voltage level and generate the power output at the boosted second voltage level.

12. The control system of claim 3, wherein the second power electronics are configured to power-down when the auxiliary power module is disconnected from the main control module.

13. The control system of claim 3, wherein the main control module further includes a diagnostic circuit configured to monitor operation of the auxiliary power module.

14. A method of controlling an engine, comprising:
directing power from a power source to a main control module;
conditioning power from the power source within the main control module;
directing power from the power source to an auxiliary power module;
conditioning power from the power source within the auxiliary power module;
directing conditioned power from the main control module to at least one component of the engine; and
directing conditioned power from the auxiliary power module through the main control module to the at least one component of the engine.

15. The method of claim 14, wherein conditioning power from the power source within the main control module includes selectively boosting a voltage of the power from a first voltage level to a second voltage level with first power electronics.

16. The method of claim 15, wherein directing conditioned power from the main control module to the at least one component of the engine includes selectively directing power at the first voltage level and power at the second voltage level to the at least one component.

17. The method of claim 16, wherein conditioning power from the power source within the auxiliary power module includes selectively boosting a voltage of the power from the first voltage level to a third voltage level with second power electronics.

18. The method of claim 17, wherein directing conditioned power from the auxiliary power module through the main control module to the at least one component includes selectively directing power at the first voltage level and power at the third voltage level through the main control module to the at least one component.

19. The method of claim 18, wherein:
directing conditioned power from the main control module to the at least one component of the engine includes selectively activating a first gate to direct power at the first voltage level to a bus, and selectively activating a second gate to direct power at the second voltage level to the bus; and
directing conditioned power from the auxiliary power module through the main control module to the at least one component of the engine includes selectively activating a third gate to direct power at the first voltage level or the third voltage level to the bus.

20. An engine, comprising:
an engine block at least partially defining a plurality of combustion chambers;
a plurality of fuel injectors associated with the plurality of combustion chambers;
a power source;
a main control module including:
first power electronics configured to receive power from the power source at a first voltage level and generate a power output at a boosted second voltage level; and
a main controller;
an auxiliary power module mechanically and electrically connectable to the main control module, the auxiliary power module including:
second power electronics configured to receive power from the power source at the first voltage level and generate a power output at a boosted third voltage level; and
an auxiliary controller in communication with the main controller;
a bus associated with the plurality of fuel injectors;
a first gate configured to selectively close a connection between the power source and the bus;
a second gate configured to selectively close a connection between the first power electronics and the bus; and
a third gate configured to selectively close a connection between the second power electronics and the bus,
wherein:
the main controller is configured to selectively activate the first power electronics, the auxiliary controller, the first gate, the second gate, and the third gate to generate a desired waveform having the first, second, and third voltage levels directed to the plurality of fuel injector; and
the auxiliary controller is configured to automatically power-down the second power electronics when the auxiliary power module is disconnected from the main control module.
